(19) United States
(12) Patent Application Publication
(10) Pub. No.: US 2015/0012353 A1
(43) Pub. Date: Jan. 8, 2015

(54) SYSTEM, METHOD, AND COMPUTER-READABLE PROGRAM FOR REAL-TIME MONITORING OF ACTIVITY

(71) Applicants: James Michael Ciancio-Bunch, Columbus, IN (US); Steve Scott, Fishers, IN (US)

(72) Inventors: James Michael Ciancio-Bunch, Columbus, IN (US); Steve Scott, Fishers, IN (US)

(73) Assignee: Exact Target, Inc., Indianapolis, IN (US)

(21) Appl. No.: 13/992,122

(22) PCT Filed: Dec. 9, 2011
(86) PCT No.: PCT/US2011/064259

§ 371 Date: Jun. 6, 2013

Related U.S. Application Data
(60) Provisional application No. 61/421,497, filed on Dec. 9, 2010.

(51) Int. Cl. G06Q 30/02

(52) U.S. Cl. CPC G06Q 30/0251; G06Q 30/0201
USPC 705/14.49

(57) ABSTRACT

A method for determining and delivering relevant campaign information from remote data sources in real-time or near real-time. Such a method includes obtaining data from a plurality of remote data sources on a network, processing the data from the remote data sources to determine relevant campaign information for a user, wherein the step of processing the data comprises categorizing the data based upon the type of data, filtering the data based on the one or more communication flows subscribed to by the user, and correlating the data. The method also includes delivering the processed data associated with the one or more communication flows to the user.

### CROSS REFERENCE TO RELATED APPLICATIONS

This patent application claims the benefit of and incorporates by reference herein the disclosure of the pending provisional application U.S. Ser. No. 61/421,497, filed Dec. 9, 2010.

### BACKGROUND

Many corporations, associations, groups, franchisors and other entities, referred to herein generally as enterprises, would like to monitor specific communications from multiple data sources including persons who have expressed an interest in receiving emails from such enterprises. The rapid expansion of communication mediums combined with the consumer's ability to speak to a mass audience in a very short time has required enterprises to react to changes in the marketplace as quickly as possible.

Today, enterprises rely on information contained within reports that are generated on a schedule from data warehouses, third party vendors, and other various data repositories. By the time enterprises review these scheduled reports, the information contained therein may no longer be timely or it may be too late for the enterprises to act on such information. For example, enterprises today have presences on Twitter®, Facebook®, Google+®, and other social media outlets. An enterprise reviewing a scheduled daily report that shows the enterprise's Facebook® page lost 50% of its fans throughout the day may have already missed the opportunity during the day to remedy the issue that caused the fans to leave. In another example, an enterprise reviewing a monthly report showing that the enterprise's Facebook® page gained 50% of its fans throughout the month may have missed a marketing opportunity to capitalize on this growth as it was happening.

Enterprises face this issue in areas wherever data is collected, and it is not limited to presences on the Internet. For example, an enterprise that receives a monthly report detailing that 50% of its emails distributed through newsletters during the month were bouncing back to the enterprise as undeliverable to end users may have missed an opportunity during the month to correct the problem and retain end users who no longer are interested in the newsletter. In another example, an enterprise reviewing a monthly sales report which indicates that its point-of-sale locations throughout the state of Illinois sold 50% more product than any previous month, may have missed an opportunity to capitalize on that demand during the month.

Another issue with reporting today is that enterprises may not filter information to only review what is relevant. The rapid expansion of communication mediums and data sources has created a plethora of raw information available to enterprises for review. However, most of this raw information may not be relevant to the enterprise. For example, an enterprise that receives a report containing a bulk of raw information concerning an email newsletter may not be able to identify the relevant information in the report due to the report containing irrelevant information or junk data.

To remedy the timeliness issues of scheduled reports, many enterprises employ internal teams or contract with third parties to manually monitor social media outlets, other communication mediums, and other information sources in real time. The problem with a manual approach is that it is costly, important data may be missed by human monitors, and not all information is able to be monitored in real time through this approach.

Accordingly, there exists a need to notify and provide enterprises with relevant information in real time from a multitude of sources. An enterprise able to react to changing trends in real time will be able to capitalize on opportunities presented in the moment or quickly remedy potential issues before they turn into crippling problems.

### SUMMARY

The disclosed system, method, and computer-readable program relate to real-time monitoring of activity and more particularly to providing real-time information to enterprises from a variety of sources. The present disclosure provides a system, method, and computer-readable program to allow users to target specific communications for monitoring.

In an exemplary embodiment of the present disclosure, where data is obtained from a plurality of remote data sources on a network, the data is processed from the remote data sources to determine relevant campaign information for a user. The step of processing the data comprises categorizing the data based upon the type of data, filtering the data based on the one or more communication flows subscribed to by the user, and correlating the data based on the one or more communication flows. Then, the processed data is associated with one or more communication flows to the user. In an exemplary embodiment of the present disclosure, the processed data delivered to the user is displayed to the user via a web portal and/or mobile application.

In one embodiment of the present disclosure, the step of obtaining data comprises receiving a first set of data at a first time and a second set of data at a second time and associating the first set of data with the first time and the second set of data with the second time. The step of processing the data comprises determining whether any portion of the second set of data is not found in the first set of data based upon a comparison of the first time and the second time and a comparison of the first set of data and the second set of data.

In an exemplary embodiment of the present disclosure, a system for the presentation of relevant campaign information in real-time or near real-time includes a data store comprising a server. The server is configured to obtain data from a plurality of remote data sources on a network, process the data based on one or more communication flows subscribed to by a user, and deliver the processed data associated with the one or more communication flows to the user. The server is electronically coupled to a plurality of remote data sources through an interface, the interface configured to allow the data store to pull data from the plurality of data sources.

In an exemplary embodiment in the present disclosure for a method for determining and delivering relevant campaign information from remote data sources in real time or near-real time, the method comprising obtaining a first set of data from a first remote data source on a network and obtaining a second set of data from a second remote data source on a network. The method also includes correlating the first set of data with the second set of data to determine relevant campaign information for a user, wherein the step of correlating the data comprises measuring the first set of data with the second set of data based on one or more communication flows. The method also includes delivering the correlated data associated with the one or more communication flows to the user.

### BRIEF DESCRIPTION OF THE DRAWINGS

The present invention is illustrated by way of example and not limitation in the figures of the accompanying drawings in which like references indicate similar elements and in which:

FIG. 1 is a block diagram of one embodiment of a system and method for real-time monitoring of activity;

FIG. 2 is a block diagram of one embodiment of a system and method for real-time monitoring of activity;

FIG. 3 is a block diagram of one embodiment of a system and method for real-time monitoring of activity;

FIG. 4 is a point-in-time screen shot of a GUI presented to a user for a real-time content module;

FIG. 5 is a point-in-time screen shot of a GUI presented to a user in a real-time content module;

FIG. 6 is a point-in-time screen shot of a GUI presented to a user in a real-time content module;

FIG. 7 is a point-in-time screen shot of a GUI presented to a user in a real-time content module;

FIG. 8 is a point-in-time screen shot of a GUI presented to a user in a real-time content module;

FIG. 9 is a point-in-time screen shot of a GUI presented to a user in a real-time content module;

FIG. 10 is a point-in-time screen shot of a GUI presented to a user in a real-time content module;

FIG. 11 is a point-in-time screen shot of a GUI presented to a user in a real-time content module;

FIG. 12 is a point-in-time screen shot of a GUI presented to a user in a real-time content module;

FIG. 13 is a point-in-time screen shot of a GUI presented to a user in a real-time content module;

FIG. 14 is a point-in-time screen shot of a GUI presented to a user in a real-time content module;

FIG. 15 is a point-in-time screen shot of a GUI presented to a user in a real-time content module;

FIG. 16 is a point-in-time screen shot of a GUI presented to a user in a portal displaying multiple real-time content modules.

FIG. 17 is a block diagram of one embodiment of a system for real-time monitoring of activity.

### DETAILED DESCRIPTION

It should be noted that the present disclosure may be implemented in connection with the platforms and/or architectures and/or methods of the disclosures set forth in U.S. Ser. No. 12/919,982, filed on Aug. 27, 2010, and U.S. Ser. No. 61/351,673, filed on Jun. 4, 2010. Although live content is referenced in U.S. Ser. No. 12/919,982, it should be understood that the disclosed subject matter can be implemented with an email service provider with any kind of data.

For the purposes of promoting an understanding of the principles of the disclosure, reference will now be made to the embodiments illustrated in the drawings and described in the following written specification. It is understood that no limitation to the scope of the disclosure is thereby intended. It is further understood that the present invention includes any alterations and modifications to the illustrated embodiments and includes further applications of the principles of the disclosure as would normally occur to one skilled in the art to which this invention pertains.

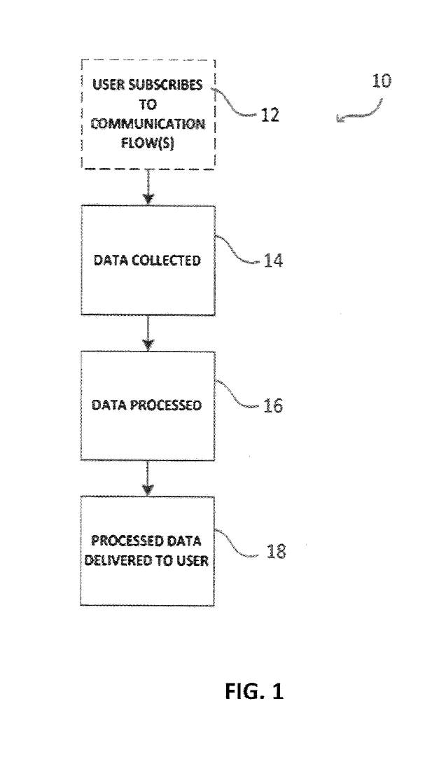

As shown in FIG. 1, a method for real-time monitoring 10 is disclosed. The method 10 includes the steps of a user subscribing to one or more communication flows 12, data is collected from one or more data sources 14, filtering relevant data 16, and presenting information to the user 18.

The step of a user subscribing to one or more communication flows 12, may include a user identifying which communication flows are of interest to the user. Communication flows define relevant information to the user from one or more data sources. Data sources may include, but are not limited to, Twitter® Feeds, Facebook®, Point-of-Sale (POS) locations, Web Analytics, Location-based Networks, Customer Relationship Management (CRM) tools, Enterprise Resource Planning (ERP), email distributions, mobile distributions, and other information sources.

Communication flows include one or more data sources and the corresponding relevant information in the one or more data sources. Enterprises may not be concerned about the entirety of available information from one or more data sources. Thus, a communication flow may include a subset of information able to be pulled from one or more data sources. For example, an enterprise interested in how its Facebook® fan page is performing may only be interested in how the number of fans for the Facebook® fan page is increasing or decreasing. Consequently, the communication flow that the enterprise may be interested in would only contain information from the Facebook® fan page associated with the number of fans.

Communication flows, therefore, may include, but are not limited to, information from Twitter® accounts, including, for example, follower information, tweets, retweets, and other information within Twitter®, Facebook® fan pages, including, for example, new likes and total fans, Facebook® applications, other social networking outlets, Point-of-Sale (POS) locations, including, for example, purchase information, and payment method, Web Analytics, including, for example, Internet protocol (IP) address, hyperlinks clicked, and duration of visit, Location-based Networks, including, for example, current location and past location, Customer Relationship Management (CRM) tools, including, for example, new customers, customer names, customer contact information, Enterprise Resource Planning (ERP), email distributions, mobile distributions, and information from other data sources. It should be appreciated that a communication flow may include information from multiple data sources or information correlated from multiple data sources.

It should be appreciated that the step of a user subscribing to one or more communication flows 12 is not a critical step. In one embodiment, a user may be a reoccurring customer or pre-existing user whereby the communication flows that the user may be interested in area already known. In one such embodiment, the user's communication flows may be automatically subscribed to due to the pre-existing knowledge of the user.

The step of collecting information from one or more data sources 14, may include pushing information from one or more data sources or the enterprise pulling information from one or more data sources. Interaction between one or more data sources may be synchronous or asynchronous. Interaction may be through, but is not limited to, API, FTP, SOAP submission, or any other communication protocol known to one or ordinary skill in the art.

It should be appreciated that a data source may support pushing or pulling information through a variety of processes. For example, a user may subscribe to a communication flow which contains follower metrics associated with a Twitter® account. One process in which the method 10 may collect information from the Twitter® data source 14, may include communication with Twitter® through the Twitter® API for Twitter® developers. In this example, bidirectional communication with the Twitter® API may occur and information may be pushed from Twitter® to the enterprise as new information becomes available or information may be pulled by the enterprise from Twitter® through communication.

In another example, information may be retrieved from one or more data sources through a feed process, like, for example, a flat file pushed by one or more data sources onto a server. It should be appreciated that information may be retrieved from one or more data sources through any communication protocol known to one or ordinary skill in the art.

In the step of processing data 16, information collected from one or more data sources 14 is processed based on the user subscribing to one or more communication flows 12. In one example, if the user subscribed to a communication flow containing information from the data source of Facebook®, specifically pertaining to the user's Facebook® fan page, then information collected from one or more data sources 14 may be filtered to only include Facebook® likes. In another example, if the user subscribed to a communication flow containing information from Facebook® and Twitter®, specifically pertaining to the user's Facebook® fan page and Twitter® account, then information collected from one or more data sources 14 may be filtered to only include Facebook® likes, Twitter® followers, tweets, and retweets.

It should be appreciated that the filtered relevant data may include data from a multitude of data sources that is correlated to become relevant to a user. For example, a user that subscribes to a communication flow 12 that is associated with the number of sales of a specific item on an online shopping tool generated from an email campaign, the relevant data for the communication flow may be the number of clicks of a link to purchase the item by recipients of emails in the email campaign, the number of purchases of the item in the online shopping tool, and the number of opened messages in the email campaign. In this example, the information is correlated between the data source of the email campaign and the data source of the online shopping tool.

In another example, a user may subscribe to a communication flow 12 that is associated with the activity to a website generated from a marketing campaign across Twitter®, Facebook®, and SMS. The relevant information to the user in this general marketing campaign may be the number of visitors to the website, the number of retweets of tweets generated in the marketing campaign, the number of followers of the Twitter® handle used in the campaign, the number of “Likes” of the Facebook® page, and the number of clicks of links within SMS messages by recipients in the campaign.

In this example, the relevant data to the user may be correlated data between all of the data sources, aggregated data from multiple data sources, and/or combined data from multiple data sources. For example, the user may be interested in the number of unique social connections reached in the marketing campaign. To generate this metric, the number of retweets, Facebook® “Likes”, and SMS clicks may be aggregated and/or correlated to determine the number of unique social connections reached in the marketing campaign.

It should be appreciated that relevant data may be timely or fresh data. For example, a user subscribing to a communication flow 12 that is associated with activity to a website generated from a marketing campaign across Twitter®, Facebook®, and SMS may only be interested in activity generated in a certain time window, like since the start of the marketing campaign, the activity over the last hour, or activity over the last day. In the step of filtering relevant data 16, information collected from one or more data sources 14 may be measured against previously collected information from one or more data sources 14 to calculate relevant information in the time window.

In the step of delivering information to the user 18, the user receives relevant information concerning the one or more communication flows that the user has subscribed. It should be appreciated the user may pull this information or the enterprise may push this information to the user. In one example, the information is presented to the user through a website viewed by a web browser or mobile device. It should be appreciated that the information may also be presented to the user through a mobile device application, notification sent via email, SMS, MMS, text message, or other real time or near-real time notification process.

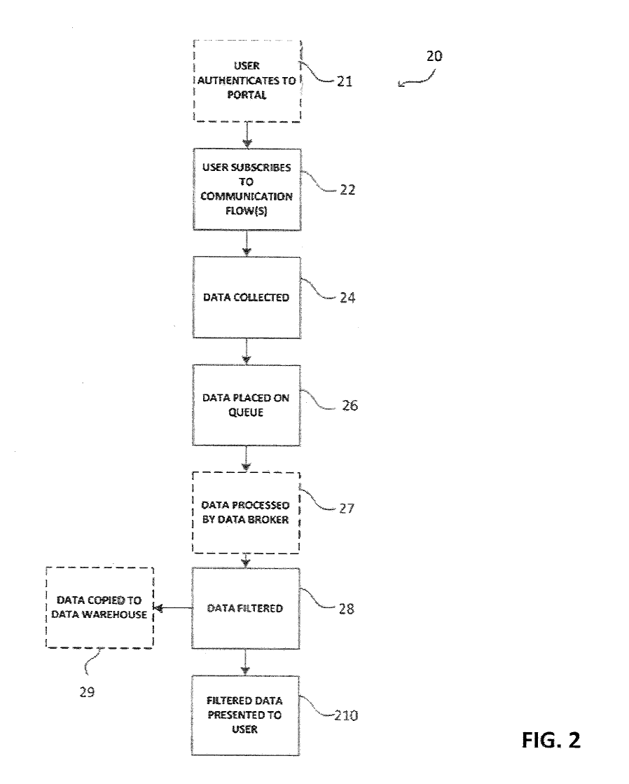

As shown in FIG. 2, one embodiment of the disclosed method 20 includes the steps of having a user authenticate to a web portal 21, the user subscribing to one or more communication flows 22, collecting data from one or more data sources 24, placing data on a data queue 26, processing data by a data broker 27, filtering relevant data 28, copying data to a data warehouse 29, and presenting data to the user 210.

In one embodiment, the user may subscribe to one or more communication flows 22 by notifying the user's customer account representative, through email request to the user's customer account representative, or other means of informing an intent to subscribe to one or more communication flows 22. In a preferred embodiment, if the user optionally logged into a web portal 21, the user may subscribe to one or more communication flows 22 through the web portal. It should be appreciated that the user may, among other ways, subscribe through the web portal by clicking on a link within the web portal, choosing one or more communication flows through check boxes, lists, or other selection methods.

In one embodiment, subscribing to one or more communication flows may cost the user a fee. A user may be required to input credit card information or other payment information during the step of subscribing to one or more communication flows 22. In another embodiment, a user's account will be billed upon the step of subscribing to one or more communication flows 22.

In one embodiment, information is collected through one or more data sources 24. The data sources may include, but are not limited to, POS, Web Analytics, Twitter®, Facebook®, Location-based Networks, social networking outlets, CRM, ERP, email distributions, mobile distributions, and other information sources. It should be appreciated that in the step of collecting information through one or more data sources 24, information may be pushed from the data source or may be pulled from the data source through an API or other means.

The following are examples of the types of data sources and information able to be obtained from the data sources. It should be appreciated that these examples are not limiting, and that any data source and any type of information may be obtained through the step of information is collected through one or more data sources 24.

POS: In one example, the data may be retrieved from a home improvement store, online store, or other POS location. The information collected from a POS may include purchase information, such as the types of goods or services that are top sellers, and coupon redemption data.

Web Analytics: In one example, the data may be retrieved from various sources that collect web analytic information. The web analytic information may include, for example, the number of times a website has been visited, the number of clicks on a story or advertisement, and tracking information containing which parts of a website a user has visited.

Twitter® Feeds: In one example, the data may be retrieved from any type of public Twitter® feed. The Twitter® feed information may include, for example, the substance of a tweet, the number of tweets in a geographic area, the number of tweets from a particular individual or set of individuals, the number of followers, and/or the number of retweets of a particular tweet.

Location-based Network: In one example, the data may be retrieved from any type of location-based network, such as, for example, Foursquare®, Gowalla, or Facebook®. The information may include, for example, the number of people in a particular location, the most visited places in a city, the names of individuals the visit a particular location more than twice in a week, and/or the deals available at each place in a city.

Social Networking: In one example, the data may be retrieved from any type of social network, such as, for example, Facebook®, Twitter®, LinkedIn, and MySpace. The information collected from social networks may include, for example, acceptance of a friend request, a user's friend list, current status of a user, number of friends of a user, the news feed of a user, wall posts, photos, and other information. Information collected through social networking may be retrieved through an open API provided by the social network, like, for example, the Twitter® API or Facebook® API. Additionally, information may be retrieved by logging into the enterprise's social networking account and scraping data from the social network or by scraping data from the social network without logging into the enterprise's account. It should be appreciated that each social network may enable the enterprise to retrieve information in various ways and this disclosure encompasses any way in which the social network enables such retrieval.

CRM: In one example, the data may be retrieved from any type of application or database and may include various types of information about a company's interactions with its customers, such as, for example, sales and marketing activities. CRMs may provide this information through an open API where the data may be pulled or the CRM may push the information, through a flat file feed process, like, for example, a database dump or comma separated report, or other processes in which information may be retrieved from a CRM known to one of ordinary skill in the art.

ERP: In one example, the data may be retrieved from any type of ERP and may include various types of information about a company's internal and external resources, such as, for example, tangible assets and financial resources. ERPs may provide this information through an open API where the data may be pulled or the ERP may push the information, through a flat file feed process, like, for example, a database dump or comma separated report, or other processes in which information may be retrieved from a ERP known to one of ordinary skill in the art.

Email distributions: In one example, the data may be retrieved through distributions of email campaigns, like, for example, the system and method as described in PCT Application US/2009/001320 assigned to ExactTarget. Information retrieved through email campaigns may include, but is not limited to, email bounceback rates, email message opens, clicks within emails, downloads of pictures within emails, purchases from clicks within emails, and subscriptions to email campaigns. In one example, whether an email is opened may be captured by introducing a web beacon into the email. In one example, clicks within emails, downloads of pictures within emails, and purchases within emails may be captured by associating a particular session ID for each email and capturing when information is pulled by an email recipient in the event that the recipient interacts with the email.

Mobile distributions: In one example, the data may be retrieved through distributions to mobile devices, including SMS, MMS, and other mobile distribution methods. Information retrieved through mobile distributions may include, but is not limited to, SMS retrieval rates, content of text messages, clicks of links within text messages, and downloads of pictures and videos within MMS messages. Mobile devices, as used in this disclosure, includes cell phones, smartphones, tablets, e-readers, and other handheld and Internet-enabled devices known to those of ordinary skill in the art.

Of course, the sources of information and types of information listed above are only examples. Additionally, the processes in which information may be retrieved from the data sources are only examples. Each data source may enable information to be retrieved from the data source through a completely different way, and it should be appreciated that this disclosure encompasses the data sources pushing information or information being pulled from the data source. That is, other sources may be used and other types of information may be collected. It should be noted that the enterprise may collect some of the information listed above on its own. For example, a large retailer may collect POS and web analytic information from its own stores and website. Alternatively, an email marketing provider, such as ExactTarget, Inc., that is used by an enterprise may provide certain internal activity information.

In the step of collecting information through one or more data sources 24, the data from one or more sources may be received by one or more data adapters and tied to data channels. Each data channel defines a set of record layouts and delivery mechanisms. The record layouts can include comma separated values, xml, json, and other formats. Delivery mechanisms may include file, rest, SOAP, and other transports.

The data adapters may read data from the data channel and may convert the data record into a json-based Event. It should be noted that metadata may be used to perform various functions, such as, for example, transformation of the data and mapping elements of the data. Each Event includes the Event Type, Receipt Time, and any other data elements contained within the original data record. The Event may be placed on a data queue 26 to eventually be processed by one or more data filters.

In one embodiment, in the step of the data is placed on a data queue 26, the data queue may be a first-in-first-out queue, a stack, or any type of queue that would be appropriately labeled as a queue to one of ordinary skill in the art. In one embodiment, the representation of the data queue may take the form of a linked list, stack, circular buffer, red/black tree, binary tree, array, hash, list, multi-dimensional array, or any data structure appropriate for queue and dequeue operations known to one of ordinary skill in the art.

In one embodiment, data may be processed by a data broker 27. The processing may remove unwanted or “junk” data by inspecting information on the queue, determining whether the information is junk, and deleting information from the queue that is determined to be junk and moving information that is not junk on to the next step of the method 20.

In one embodiment, the step of filtering relevant data 28 may include filtering information to only include information relevant to the communication flows in which the user is subscribed. For example, if the user is only subscribed to the communication flow for Facebook® fan information, then the step of filtering relevant data 28 may filter out all information not pertaining to the user's Facebook® fans. In this example, the step of filtering relevant data 28 may only pass the number of new Facebook® fans of the user's Facebook® page and may discard information pertaining to the user's Twitter® account, POS, Web Analytics, and other information sources.

It should be appreciated that the user may subscribe to a communication flow that contains the combination of information from one or more data sources. In one example, a communication flow may combine information obtained from mobile distributions and Facebook® pages. In this example, the relevant data may be the relationship between the number of users that clicked a link within an SMS distributed during the mobile distribution and then subsequently liked the Facebook® page. In this example, the information from multiple data sources is relevant and would proceed to the next step in the method 10.

In one embodiment, the step of filtering relevant data 28 includes pulling events from the queue and passing the events through a series of data filters. The type of event and/or metadata may be used to determine the sequence and the type of data filters applied to the event. The filtering step includes implementing rules in data filters to sort out the incoming data communication such that users can receive targeted specific communication, such as, for example, information relating to the singer Soulja Boy. The filtering step also includes identifying any incomplete records and any records that do not need to be further processed, as well as filling in the job, campaign, person, and other information for a record.

In one embodiment, the method 20 includes presenting information to the user 210. The information may be presented to the user through a website viewed by a web browser or mobile device. It should be appreciated that the information may also be presented to the user through a mobile device application, notification sent via email, SMS, MMS, text message, or other real-time notification process.

It should be appreciated that the step of presenting information to the user 210 may occur in real time or near-real time when the information is pushed to the user. The user may also pull information in the step of presenting information to the user 210.

In one embodiment, the user may indicate alerting thresholds that notify the user upon any relevant information reaching or passing any such alerting thresholds. For example, a user may request that the user be informed in the event that the user's Facebook® fan page loses 10 fans in a given hour. Upon the method 20 identifying that the user's Facebook® fan page has lost 10 fans in a given hour, the method 20 may present information to the user 210 through a notification, like, for example, SMS message, MMS, email, alarm image on a web browser, or any other notification process known to one of ordinary skill in the art.

It should be appreciated that the user may select any thresholds for alarms on any relevant information in one or more communication flows in which the user has subscribed. For example, the user may choose to be alerted in the event that the user's Facebook® fan page loses 10 fans in an hour and the user's Twitter® account loses 15 followers in the same hour. The method 20 may alert the user by presenting information to the user 210 through a notification process when the user's Twitter® account loses 15 followers and the user's Facebook® fan page loses 10 fans in the same hour.

In one exemplary embodiment, the method 20 of allowing users to target specific communications for monitoring includes pushing filtered data to end users instead of the end user or end user's system requesting or otherwise placing a call to receive such data. In one embodiment, the user may have a web browser open and the push mechanism may include, but is not limited to, an application within a web page containing an HTMLS websocket or Comet application. This push step allows for greater or improved scalability by removing the load impact of a user refreshing a web page or requesting data frequently. However, it should be appreciated that this disclosure includes presentation through a pull mechanism by the user whereby a web browser is instructed by a web page to refresh the web page or a module therein frequently to determine whether new information is available.

In one exemplary embodiment, initially, the method 20 may require a user to authenticate to a web portal 21. It should be appreciated that this web portal may reside on a local area network (LAN), wide area network (WAN), the Internet, locally on the user's computer, or on any other network known to one of ordinary skill in the art. The login mechanism to the web portal may include a user inputting a username and password through a form, authentication through a stored session cookie, authentication through PM, authentication through a third party's authentication API, like, for example, authentication through Facebook® Platform using OAuth, and any other authentication mechanism known to those skilled in the art.

In one exemplary embodiment, the method 20 may include the step of copying filtered and relevant data to a data warehouse 29. The copied data may be transformed, compressed, or otherwise altered before copied into the data warehouse. It should be appreciated that the data warehouse may include a database, file repository, or other storage mechanisms known to those of ordinary skill in the art.

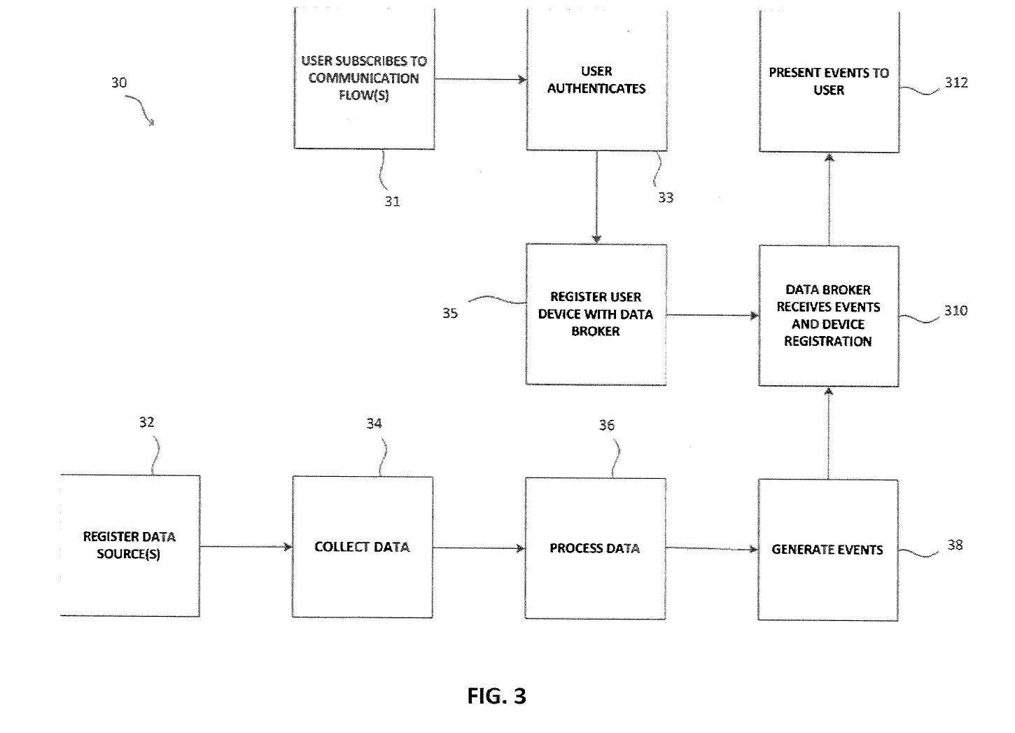

As shown, for example, in FIG. 3, one embodiment of the disclosed method 30 includes the steps of registering data source(s) 32, collecting data 34, processing data 36, generating events 38, a user subscribing to communication flow(s) 31, the user authenticating 33, registering the user device 35, a data broker receiving registration and events 310, and presenting events to the user 312.

In one exemplary embodiment, the method 30 includes the step of registering data source(s) 32. In the step of registering data source(s) 32, one or more data sources provides information about how data may be pushed from the data source or pulled from the data source. The information provided by the data source may include, but is not limited to, the type of data available on the data source, the manner in which data may be obtained, and metadata. For example, Facebook® may register as a data source by providing the information that the type of data available through Facebook® for an individual Facebook® profile includes the profile id, the name associated with the profile, the username, the gender, and the “Likes” of the individual user. The information provided during registration may additionally include how to obtain the data, like, for example, Facebook® data may be obtained through the Facebook® Developer API. Further, the information provided during registration may include various metadata associated with the type of data and/or the data source.

It should be appreciated that in the step of registering data source(s) 32, information may be pushed from the data source or pulled from the data source. For example, a data source with an open API may provide the information through queries for the information using the API, like, for example, through the Facebook® Developer API. In another example, a point-of-sale machine may provide the information during registration by submitting the type of data, manner in which data may be obtained, and other information.

It should be appreciated that the manner in which data may be obtained may include, but is not limited to, communication through an API, a feed process, a submission of data from the data source, a user manually entering information in a web form, and pulling information from the data source.

In one exemplary embodiment, the method 30 includes the step of collecting data 34 and processing data 36. In the step of collecting data 34, one or more data sources pushes data or data is pulled from one or more data sources. After data collection, in the step of processing data 36, the data is processed by one or more of the following: filtered, categorized, linked, aggregated, and other data manipulation processes. Filtering data may include, but is not limited to, removing unwanted or junk data, removing old or irrelevant data, and removing data outside of the scope of the type of data obtainable from the data source as defined in the step of registering the data source 32. Categorizing data may include, but is not limited to, associating the obtained data with one or more previously acquired data to group with similar characteristics, information, and/or properties as the obtained data. Linking the data may include, but is not limited to, assigning the data to one or more enterprises, clients, profiles, or accounts, associating the data with one or more previously acquired data of the same enterprise, clients, profiles, or accounts, and associating the data with the data source from where the data was obtained. Aggregating data may include, but is not limited to, measuring the data with previously acquired data to determine relevant data concerning one or more data sources. For example, an email campaign may send emails to a number of consumers of an online shopping tool with a link inside the email to the online shopping tool. The method 30 may collect data 34 from the email campaign, for a specific time window, including the number of users that have opened an email and the number of users that have clicked a link within an email. The online shopping tool, as another data source, may provide information, in a specific time window, concerning the number of sales, the number of hits to the online shopping tool, and the revenue generated from purchases. In the step of processing data 36 in this example, the data may be correlated from the multiple data sources to determine how many new sales occurred in the specific time window due to the number of clicks within emails generated in the email campaign and the number of emails opened in the email campaign. In another example, in the step of processing data 36 in this example, the data may be categorized to associate the number of hits to the online shopping tool with the enterprise associated with the online shopping tool.

In an exemplary embodiment, in the step of generating events 36, a rule engine checks for user subscribed communication flows and generates an event if a user subscribed communication flow matches the processed data 36. For example, a user subscribes to a communication flow 31 that contains the number of Likes of a Facebook® fan page, the clicks of a link to a website within a Facebook® fan page, and the number of unique hits to the website. If, in the step of processing data 36, data is linked to the communication flow, then the rules engine will generate an event 38 from the processed data comprising the collected number of Likes of a Facebook® fan page, the clicks of a link to a website within a Facebook® fan page, and the number of unique hits to the website collected.

It should be appreciated that an event may include data processed 36 from a variety of data sources or a single data source. An event may also include correlated data from one or more data source, like, for example, the number of opens of emails within an email campaign and the number of hits to a website where a link inside the emails directs recipients to the website. In another example, an event may contain processed data from one data source, like, for example, the number of Likes of a Facebook® page or the number of Followers of a Twitter® handle.

In an exemplary embodiment, the method 30 includes the steps of a user subscribing to one or more communication flows 31, the user authenticating 33, and the user registering the user's device with a data broker 35. In the step of the user authenticating 33, the user provides credentials indicating that the user has authorization to view events. It should be appreciated that the user may authenticate through a web browser, mobile application, and any other device able to receive events from the data broker 312. In the step of a user's device registering with the data broker 35, the user's device communicates with the data broker to indicate that the user's device is authenticated and able to receive events. The user's device transmits information to the data broker including, but not limited to, the capabilities of the user's device, the type of the user's device, the subscribed to communication flows by the user, and that the user's device is available to receive events.

In one embodiment, the method 30 includes the steps of a data broker receiving registration and events 310 and the data broker presenting events to a user 312. In the step of a data broker receiving registration of a user's device and events 310, the data broker associates a user's device registration 35 with the generated events 38 to determine what, if any, events should be presented to the user. If the data broker determine that one or more generated events 38 are associated with the one or more subscribed to communication flows 31 for a registered user's device 35, then the data broker will present the one or more events to the user's device 312. It should be appreciated that the presentation to the user's device 312 may include a text display, graphical display, graph, message, module in a web portal, push-notification to a mobile device, or other presentation medium known to one of ordinary skill in the art.

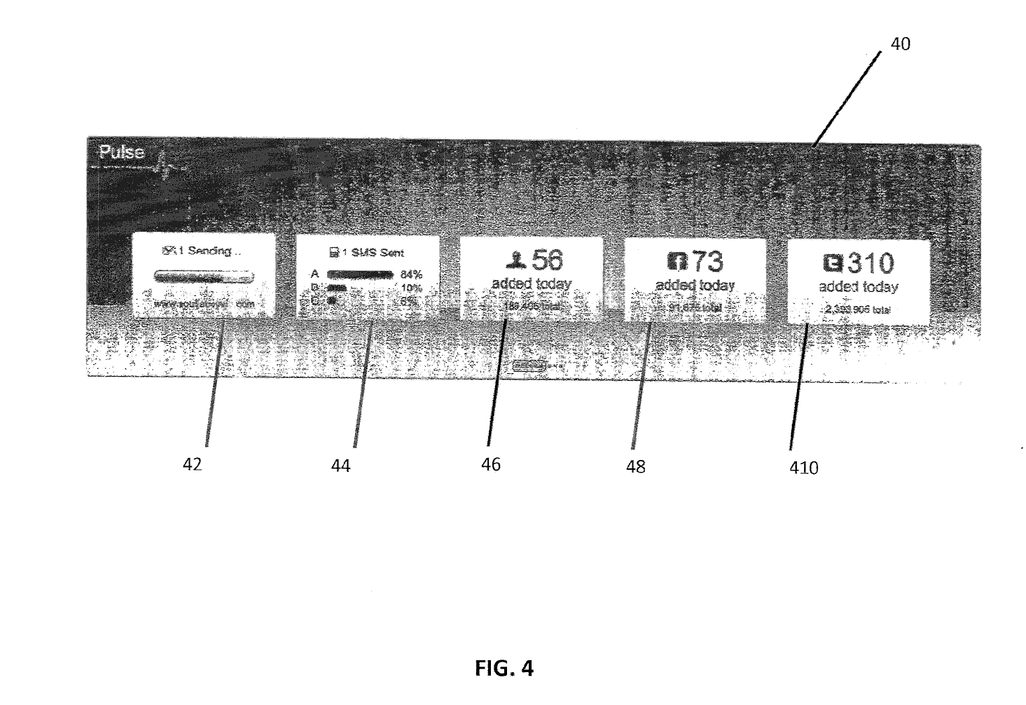

The following discussion relating to FIGS. 4-16 describes an example of a system and computer-readable program that comprises the steps of the method described above. The system and computer-readable program described in FIGS. 4-16 is referred to herein as the Pulse Data tool.

As shown, for example, in FIG. 4, the method and system for real-time monitoring of subscribed activity may be represented through a software as a service (SaaS) model on a portal 40. The portal 40 may include, but is not limited to, a web page, web portal, mobile application, email, and MMS. In one embodiment, the portal 40 may display relevant data to the user regarding the communication flow of an email send job through an email module 42 including, for example, a status bar, indication of status, and name of the email send job. The portal 40 may also display relevant data to the user regarding an SMS campaign through an SMS campaign module 44 including, for example, the number of SMS sent, the responses from end users to the SMS campaign, and the number of unsuccessful SMS send attempts. In another example, the portal 40 may include relevant information concerning the communication flow of an email newsletter through an email newsletter module 46 including, for example, the number of new subscribers to the email list for that day and the number of total subscribers. In another example, the portal 40 may include relevant information concerning the communication flow of a Facebook® page through a Facebook® module 48 including, for example, the name of the page, the number of “likes” for the day, and the total number of fans. In another example, the portal 40 may include relevant information concerning the communication flow of a Twitter® feed through a Twitter® module 410 including, for example, number of tweets added in a day, number of followers added in a day, and the total number of followers.

In one embodiment, as displayed on FIG. 4, a user interacting with the portal 40 may review real time or near-real time information modules of a variety of communication flows spanning multiple communication sources. In this example, the user may view a email module 42, SMS campaign module 44, email newsletter module 46, Facebook® fan page module 48, and a Twitter® module 410. It should be appreciated that the user may view any number of modules detailing information from a variety of communication sources on the portal 40.

It should be appreciated that the portal 40 displayed in FIG. 4 is a point-in-time representation of one embodiment of the method and system for real-time monitoring of subscribed activity. As new data is processed and filtered for relevant information, it may be pushed to the user or pulled by the user and displayed on the portal 40. For example, if a Facebook® user likes the Facebook® page subscribed to in the communication flow, then the relevant information concerning the communication flow of a Facebook® page 48 will be updated in real time to reflect the new fan.

It should be appreciated that the modules displayed in the portal 40 in FIG. 4 are only examples of the types of modules for communication flows in the method and system for real-time monitoring of subscribed activity. Any relevant information from one or more communication flows may be presented to the user in the portal 40.

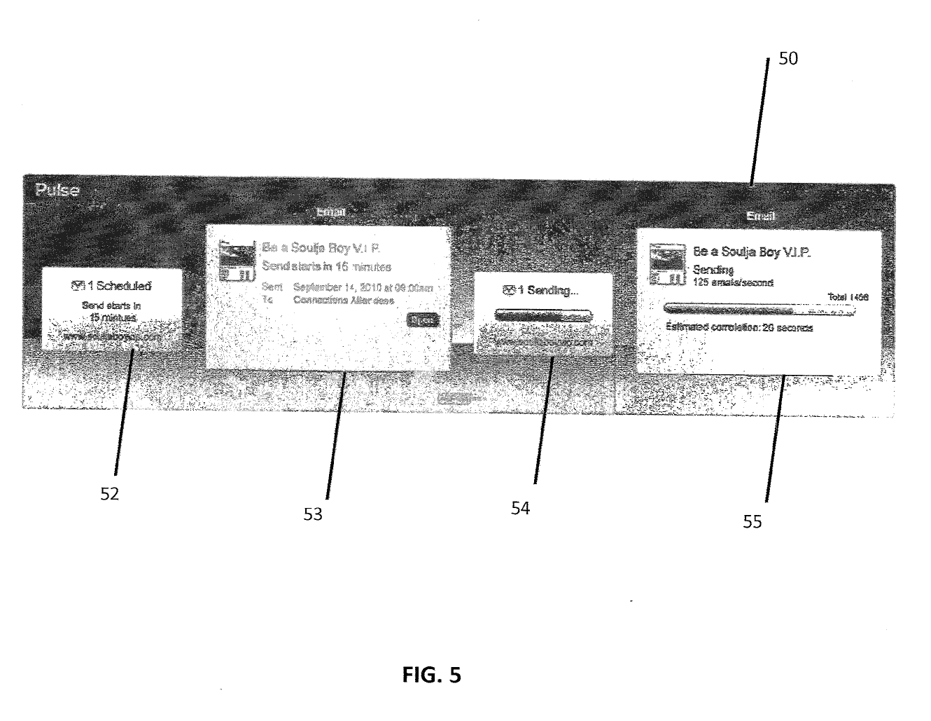

As shown, for example, in FIG. 5, the method and system for real-time monitoring of subscribed activity may be represented through a software as a service (SaaS) model on a portal 50. In this example, a user has subscribed to a communication flow pertaining to status, progression and other metrics concerning an email send job. In real time or near-real time, the portal 50 may display the status, progression, and metrics of a scheduled or real-time requested email send job 52. It should be appreciated that this FIG. 5 represents a point-in-time view of one embodiment of the method and system for real-time monitoring of subscribed activity. As the system obtains new information from one or more data sources that may be relevant to the user's subscribed communication flows, the system may push or the user may pull new relevant information in real time or near-real time, thereby updating the metrics of a scheduled or real-time requested email send job 42 in the portal 50.

In an exemplary embodiment, a user may schedule an email send job and subscribe to the communication flow for the email send job. The portal 50 may notify the user fifteen minutes prior or any other time to the release of the email send job through a module 52. The portal 50 may provide additional information to the user through a pop-up 53 when information is updated in real time or near-real time or the user clicks the module 52, like, for example, the distribution list of the email send job, the name of the email send job, a picture associated with the email send job, the time in which the email send job will be started, and the status of the email send job. Upon the time in which the email send job will be started, the portal 50 may be updated in real time or near-real time to display the status of the job 54 through, for example, a status bar or status message. As the email send job progresses, the portal 50 may display additional information to the user through a pop-up, new window, or transformation of the module 55 when information is updated in real time or near-real time or the user clicks the module 54 like, for example, the total number of emails sent, the number of emails left, a progress bar, the name of the email job, the status of the email job, the rate at which emails are being sent, and the estimated completion time.

It should be appreciated that a user may schedule an email send job or request an email send job to occur directly with the portal 50. It should also be appreciated that information displayed within the portal 50 may be updated in real time or near-real time and be pushed to the user's browser, mobile application, and the like or may be pulled by the user.

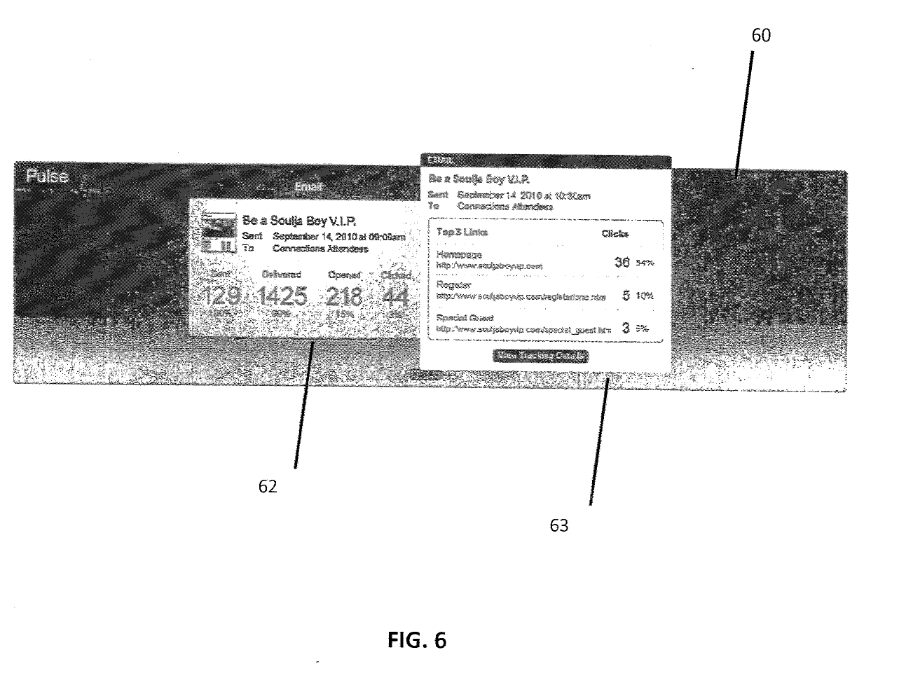

As shown, for example, in FIG. 6, the method and system for real-time monitoring of subscribed activity may be represented through a SaaS model on a portal 60. Upon completion of an email send job, like, for example, the email send job described in FIG. 5, the portal 60 may allow a user to retrieve detailed information about the email send job by the user clicking the status module 62 or automatically in pop-up when the email send job completes. The detailed information about the email send job may be represented in a detailed module 63 and may include, for example, the name of the email send job, the date of completion of the email send job, the number of clicks of each link within emails by recipients in the email job, and further tracking details.

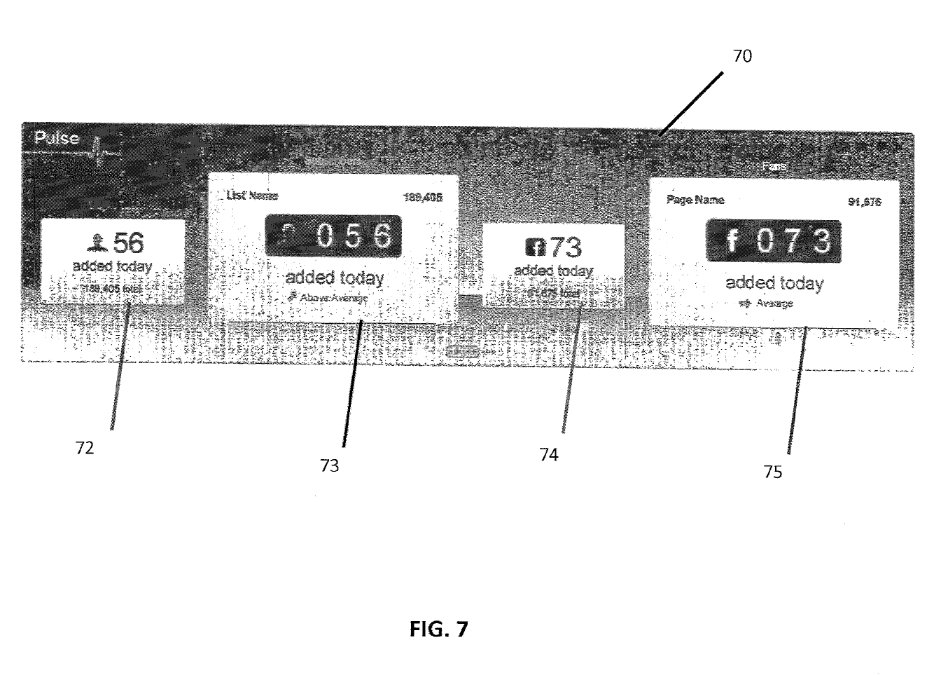

As shown, for example, in FIG. 7, the method and system for real-time monitoring of subscribed activity may be represented through a SaaS model on a portal 70. The portal 70 may include various modules containing information relevant to a user per the user's subscribed communication flows. For example, the portal 70 may contain an email newsletter module 72 that details how many recipients are subscribed to an email newsletter and how many new recipients have subscribed today. Upon clicking the email newsletter module 72 or upon receipt of new information in real time or near-real time, additional information may be displayed in a detailed email newsletter module 73, like, for example, the name of the email newsletter, the number of recipients added today, the total number of recipients, and how the number of new email recipients today compares to previous days. In one embodiment, the portal 70 may also include a Facebook® fan page module 74 that includes information about the status of the user's Facebook® fan page, like, for example, the total number of Facebook® fans and the number of new Facebook® users who have liked the fan page in that day. The portal 70 may also display additional information through a detailed Facebook® fan page module 75 when new information is pushed to the user in real time or near-real time or the user clicks on the Facebook® fan page module 74, like, for example, the total number of Facebook® users who have liked the fan page in that day, the total number of Facebook® fans of the page, and how the number of new Facebook® likes compares to previous days.

It should be appreciated that information displayed in FIG. 7 through the modules displayed on the portal 70 may be updated in real time or near-real time with new information. FIG. 7 is a point-in-time and non-limiting example of the types of information that may be displayed in the portal 70.

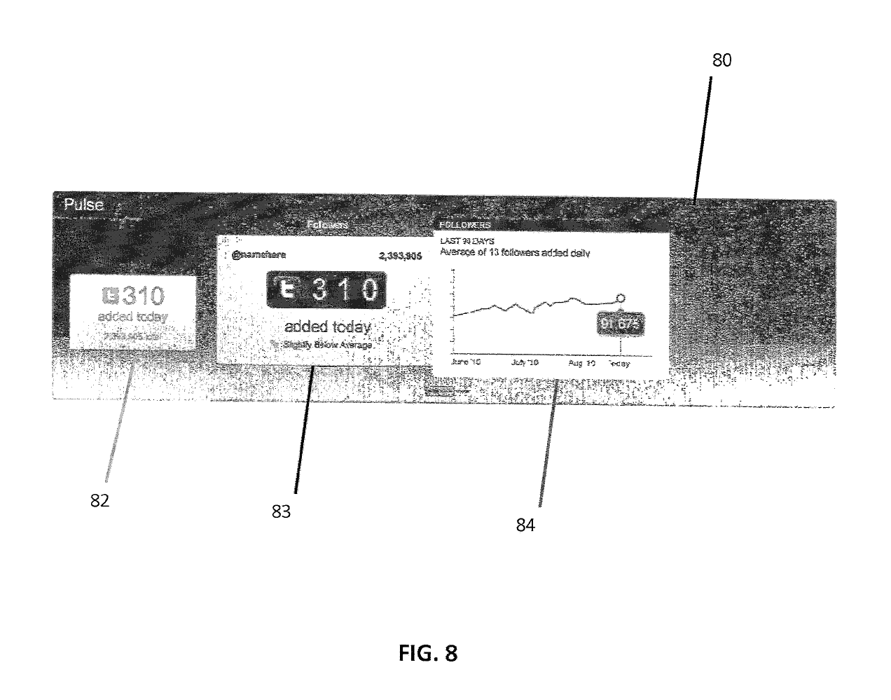

As shown, for example, in FIG. 8, the method and system for real-time monitoring of subscribed activity may be represented through a SaaS model on a portal 80. The portal 80 may include various modules containing information relevant to a user per the user's subscribed communication flows, like, for example a Twitter® Feed. The module for a Twitter® Feed 82 may be displayed on a portal 80 with information relevant to the user, like, for example, the number of Twitter® followers and the number of new Twitter® followers in a day. Upon clicking on the Twitter® module 82 or if information is pushed to the user in real time or near-real time or pulled by the user, a detailed Twitter® module 83 may be displayed with additional information, like, for example, the total number of followers, new followers in a day, and how the number of new followers in a day relates to previous days. The portal 80 may also display a followers graph 84 that details in graph form how the number of new followers in a day relates to previous days.

The followers graph 84, detailed Twitter® module 83, and Twitter® module 82 may update in real time or near-real time as new information is pushed to the user's web browser or mobile application or the user pulls information. It should be appreciated that the followers graph 84 is only one example of the type of reporting information available to the user. Other modules described herein or related to other communication flows may be displayed to the user through the portal 80.

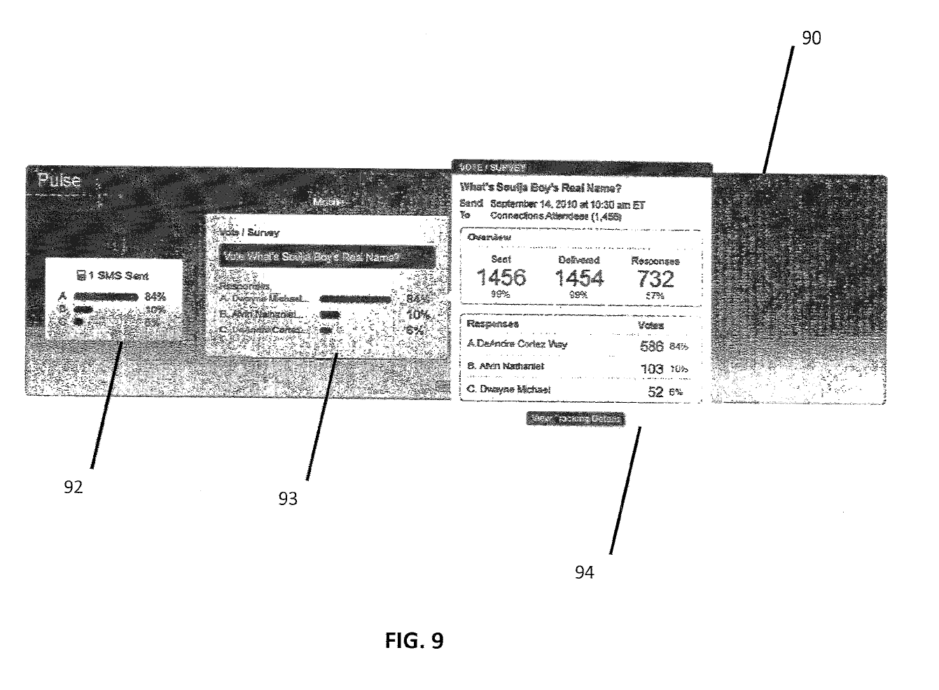

As shown, for example, in FIG. 9, the method and system for real-time monitoring of subscribed activity may be represented through a SaaS model on a portal 90. The portal 90 may include the module for a mobile campaign communication flow 92. The module 92 may indicate responses from recipients to a SMS campaign that asked users to respond. When the user clicks the module 92 or new information is pushed to the module 92, a more detailed popup 93 may be presented to the user. The detailed pop up 93 may contain more information about the SMS campaign, like, for example, the question presented to recipients of the SMS, the options for the recipients to choose, and the percentage of responses for each option. The user may obtain further information through an additional detailed pop up 94 by clicking the detailed pop up 93. The additional detailed pop up 94 may represent further information concerning the SMS campaign, like, for example, the total number of sent SMS messages, the number of replies, the number of successfully delivered messages, the send date, and the recipient list. It should be appreciated that the point-in-time representation of the portal 90 in FIG. 9 may display updated information as information is pushed to the user or the user requests a refresh of presented information.

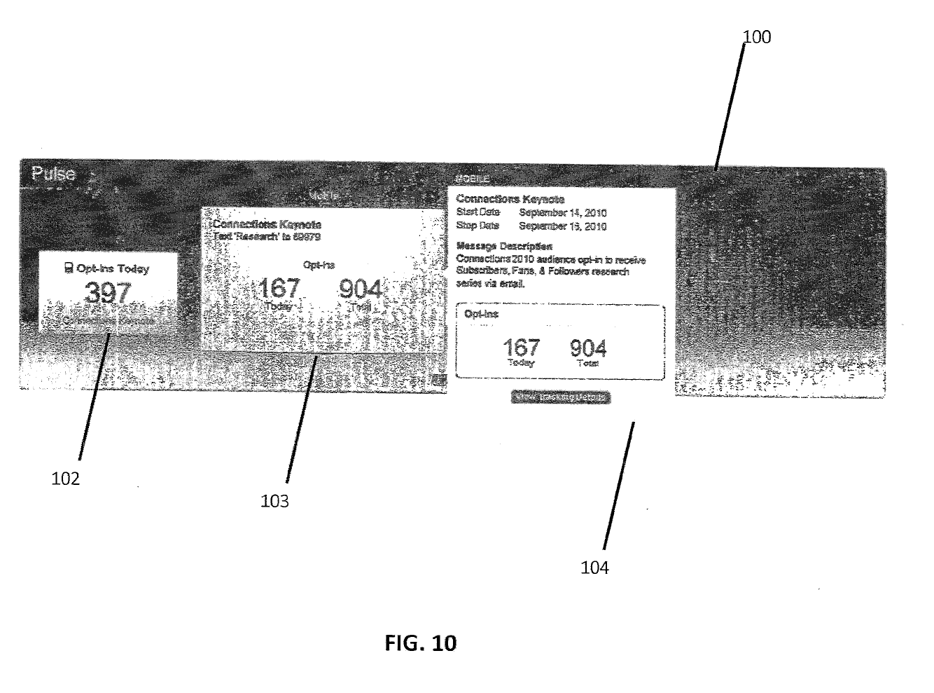

As shown, for example, in FIG. 10, the method and system for real-time monitoring of subscribed activity may be represented through a SaaS model on a portal 100. The portal 100 may include the module for an email campaign 102. The module for an email campaign 102 may present information to the user in real time or near-real time, including, for example, the number of users who have subscribed to an email newsletter and the name of the email newsletter. When the user clicks the module 102 or new information is pushed to the module 102, a detailed information module 103 may pop up which displays more detailed information to the user about the email campaign. The information included in the detailed module 103 may be, but is not limited to, the total number of subscribers to the newsletter, the number of new subscribers to the newsletters, and the method in which users may subscriber to the newsletter.

As shown, for example, in FIG. 11, the method and system for real-time monitoring of subscribed activity may be represented through a SaaS model on a portal 110. The portal 110 may include the Foursquare® module 112. The Foursquare® module 112 may present information to the user in real time or near-real time, including, for example, the number of total checkins in a geographic location within the user's subscribed communication flow. When the user clicks the Foursquare® module 112 or new information is pushed to the Foursquare® module 112, a detailed information module 113 may pop up which displays more detailed information to the user about Foursquare® activity within the user's subscribed communication flow, like, for example, a map with pinpoints showing Foursquare® checkins throughout the city of Indianapolis. The map may be generated using one or more mapping services, like, for example, Google Maps, Bing!®, Yahoo! Maps, and MapQuest. When the user clicks the detailed information module 113, further information may be presented to the user through a popup 114, like, for example, the name of the geographic location clicked on the detailed information module 113.

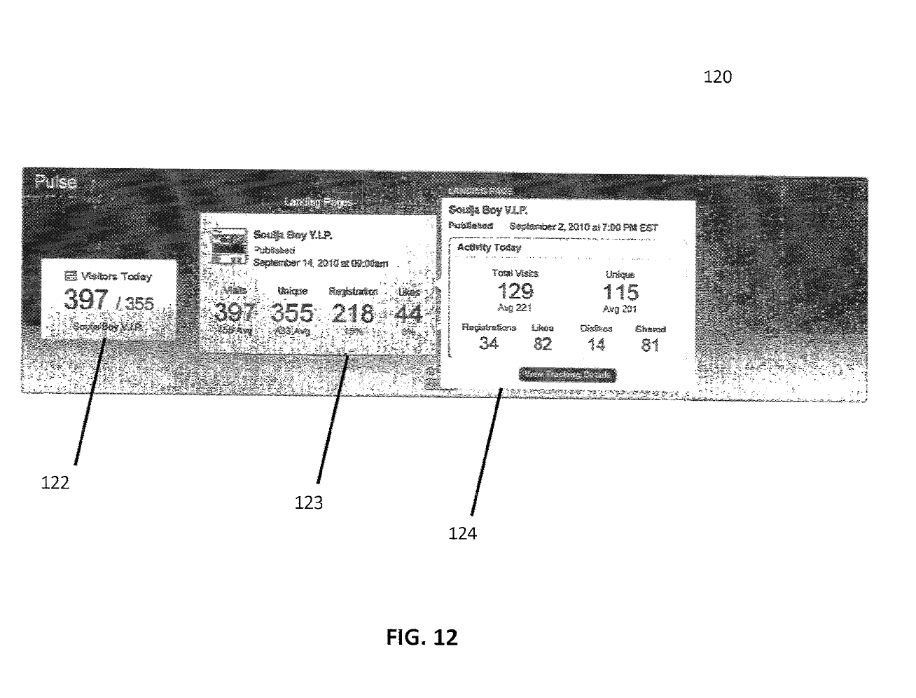

As shown, for example, in FIG. 12, the method and system for real-time monitoring of subscribed activity may be represented through a SaaS model on a portal 120. The portal 120 may include the analytics module 122 for a landing page available on the Internet. The analytics module 122 may present information to the user in real time or near-real time, including, for example, the total number of visits and the unique number of visits to a landing page available on the Internet within the user's subscribed communication flow. When the user clicks the analytics module 122 or new information is pushed to the analytics module 122, a detailed information module 123 may pop up which displays more detailed information to the user about activity within the user's landing page, like, for example, the total number of visits to the landing page, the number of unique visits to the landing page, the number of Facebook® likes clicked on within the landing page, the number of registrations on the landing page, the date in which the landing page was published, a point-in-time picture of the landing page, and the name of the landing page. When the user clicks the detailed information module 123, further information may be presented to the user through a popup 124, like, for example, specific activity on the landing page today, including likes, registrations, total visits, unique visits, and number of Facebook® shares.

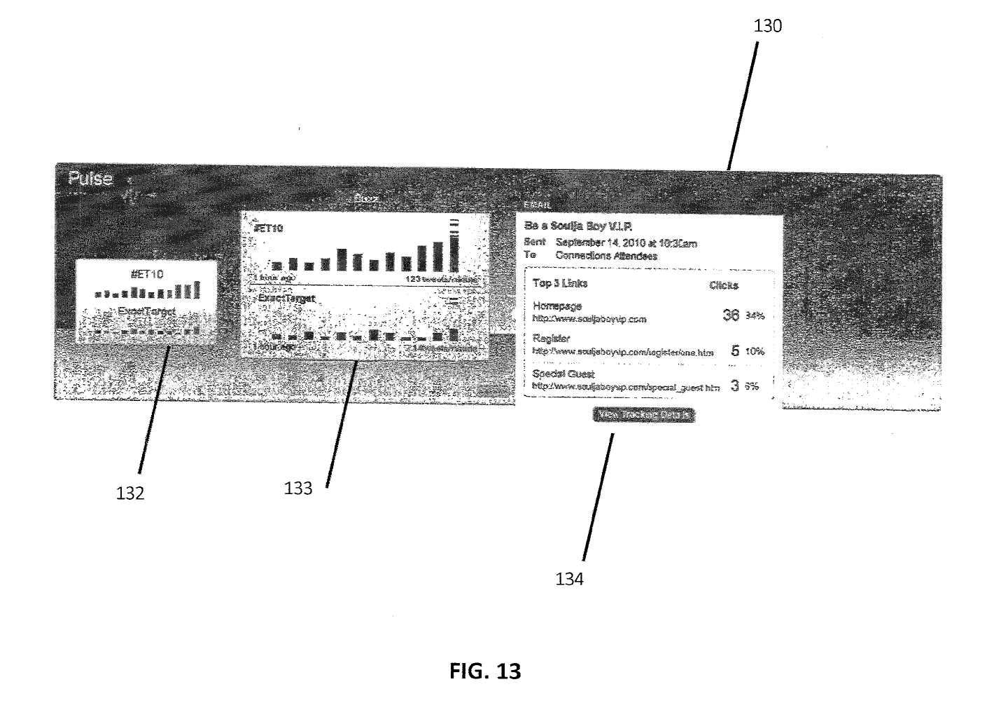

As shown, for example, in FIG. 13, the method and system for real-time monitoring of subscribed activity may be represented through a SaaS model on a portal 130. The portal 130 may include the Twitter® buzz module 132. The Twitter® buzz module 132 may present information to the user in real time or near-real time, including, for example, a graph displaying the number of tweets associated with a Twitter® hashtag, Twitter® account, or tweets containing a keyword. When the user clicks the Twitter® buzz module 132 or new information is pushed to the Twitter® buzz module 132, a detailed information module 133 may pop up which displays more detailed information to the user about Twitter® activity, like, for example, a detailed graph displayed the number of tweets per minute associated with a Twitter® hashtag, Twitter® account, or tweets with a certain keyword present. When the user clicks the detailed information module 133, further information may be presented to the user through a popup 134, like, for example, the top three links contained within tweets in a specific Twitter® hashtag, Twitter® account, or tweets with a specific keyword and the number of clicks of the links.

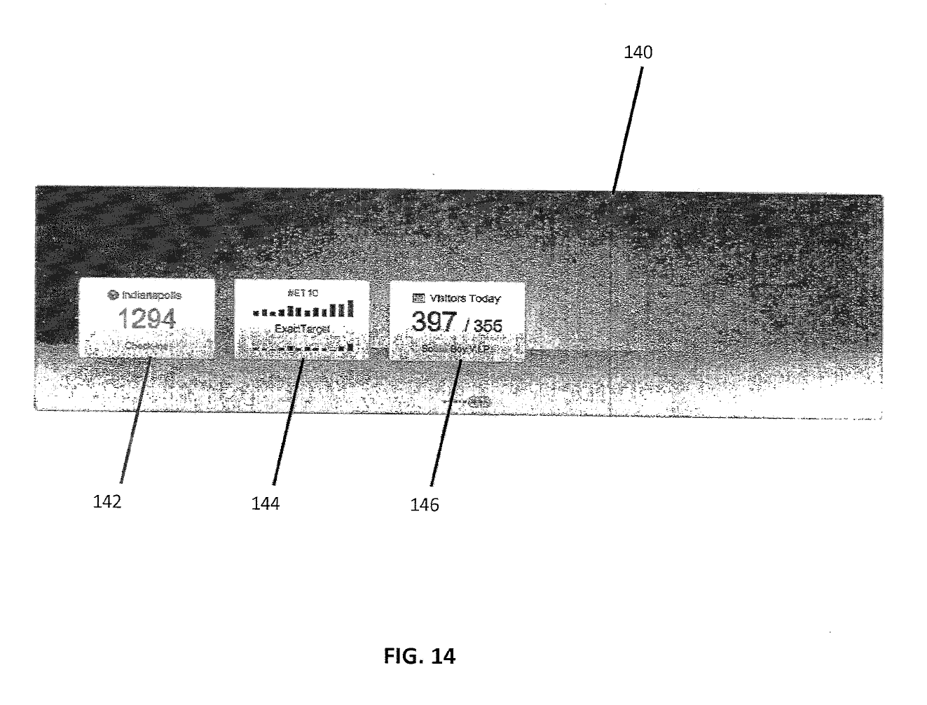

As shown, for example, in FIG. 14, the method and system for real-time monitoring of subscribed activity may be represented through a SaaS model on a portal 140. The portal 140 may include multiple modules disclosed herein, like for example, the Foursquare® module 142, the Twitter® Buzz module 144, and the analytics module 146. The individual modules displayed on the portal 140 may present further information to the user when the user clicks on the individual modules, new information is pushed to the modules, or the user requests new information through his or her web browser. It should be appreciated that this point-in-time representation of the portal 140 only includes a few examples of the types of modules that may be displayed in the portal 140. The portal 140 may display any module to the user that displays relevant information pertaining to the user's subscribed communication flows.

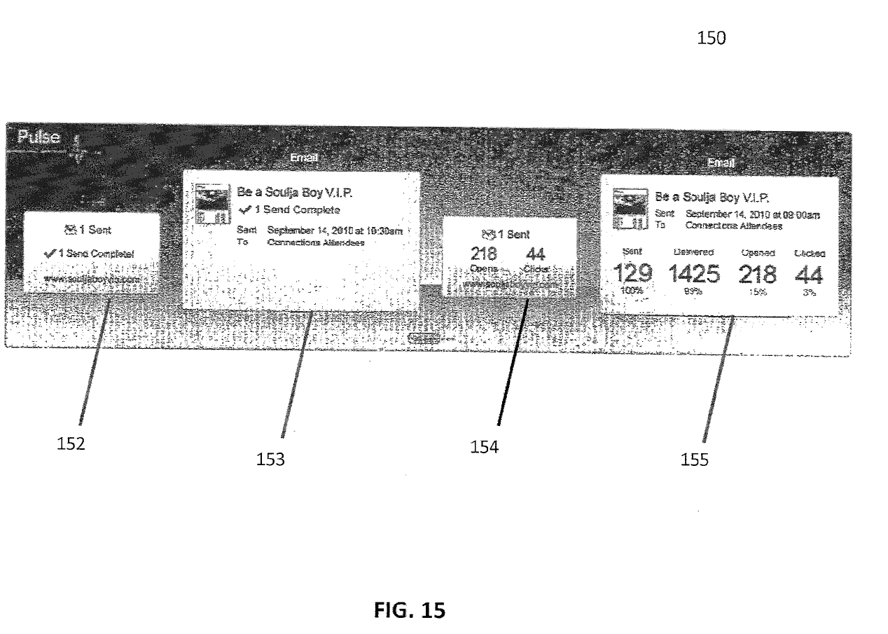

As shown, for example, in FIG. 15, the method and system for real-time monitoring of subscribed activity may be represented through a SaaS model on a portal 150. Upon completion of an email send job, like, for example, the email send job described in FIG. 5, the portal 150 may update and display in real time or near-real time that the email send job has been completed 152. If a user clicks the module 152 or new information is available in the module 152, then the portal 150 may display additional information about the email send job in a pop-up or transformation 153, like, for example, the status of the email send job as complete, the date of the scheduled email send job, the name of the email send job. The portal 150 may also display information about recipient's activities of emails received through the email send job 154 like, for example, how many recipients opened the email, how many recipients clicked a link within the email, and how many recipients never received the email. The portal 150 may also display additional information about the email send job when the user clicks the module 154 or new information is available through a pop-up 155.

It should be appreciated that the information displayed through the portal 150 may be updated in real time or near real time as more recipients open, receive, click links, or otherwise interact with emails sent through the email send job. For example, if a recipient of an email in the email send job clicks a link within the email, the portal 150 may update the number of clicks in real time or near-real time.

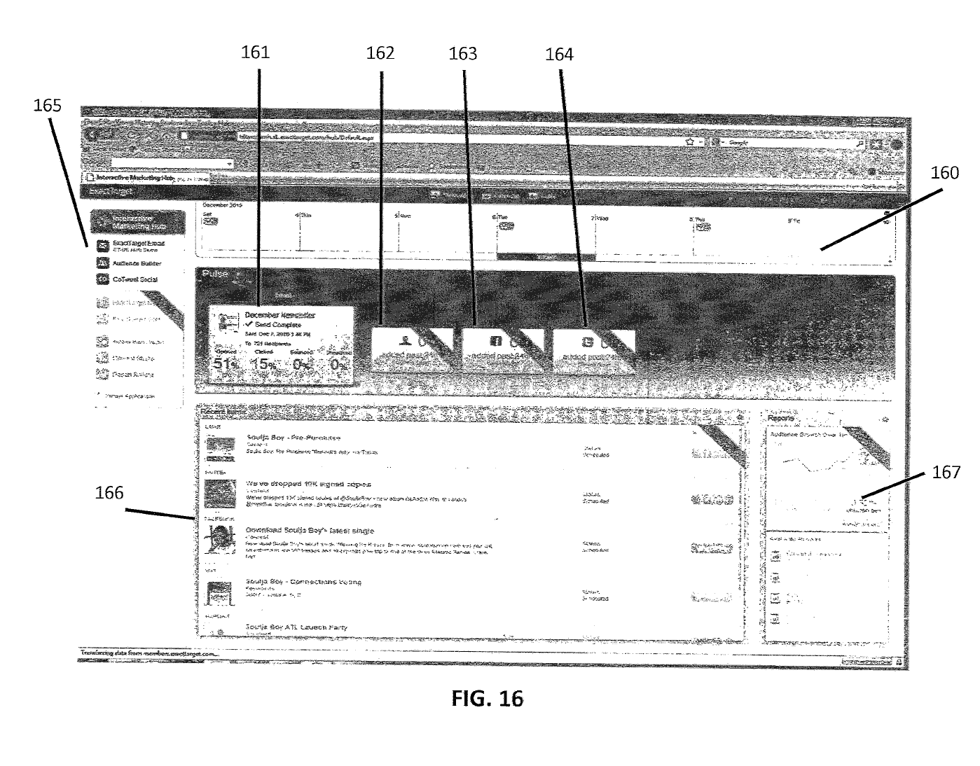

As shown, for example, in FIG. 16, the method and system for real-time monitoring of subscribed activity may be represented through a SaaS model on a portal 160. The portal 160 may contain numerous modules within a Pulse Data Tool section, like, for example, the email newsletter module 161, the email subscription module 162, the Facebook® fans module 163, and the Twitter® followers module 164. It should be appreciated that the modules displayed within the portal 160 may include information from the same data source, but the relevant information for each module may be different. For example, the portal 160 contains the email newsletter module 161 and the email subscription module 162. In this example, the data source for both modules may be information pulled or pushed from the same email campaign.

However, the user may subscribe to multiple communication flows for the same data source. In this example, the user may be interested in the number of new subscribers, opt-ins, purchases, and other success metrics or key performance indicators to this email campaign, which is displayed in the email subscription module 162. The user may also be interested in the number of subscribers who have clicked on links within emails in the email campaign, the number of subscribers who have opened emails in the email campaign, and other information concerning the actual send job of the email campaign itself, which is displayed in the email newsletter module 161.

The portal 160 may also contain other reporting information outside of the Pulse Application, like, for example, the portal 160 may be a part of a larger Interactive Marketing Hub 165, complete with links to other reporting sections of the Interactive Marketing Hub 165. The Interactive Marketing Hub 165 may include, for example, reports 167 that may be relevant to the user, recent items 166 browsed by the user on the Interactive Marketing Hub 165, and other reporting information.

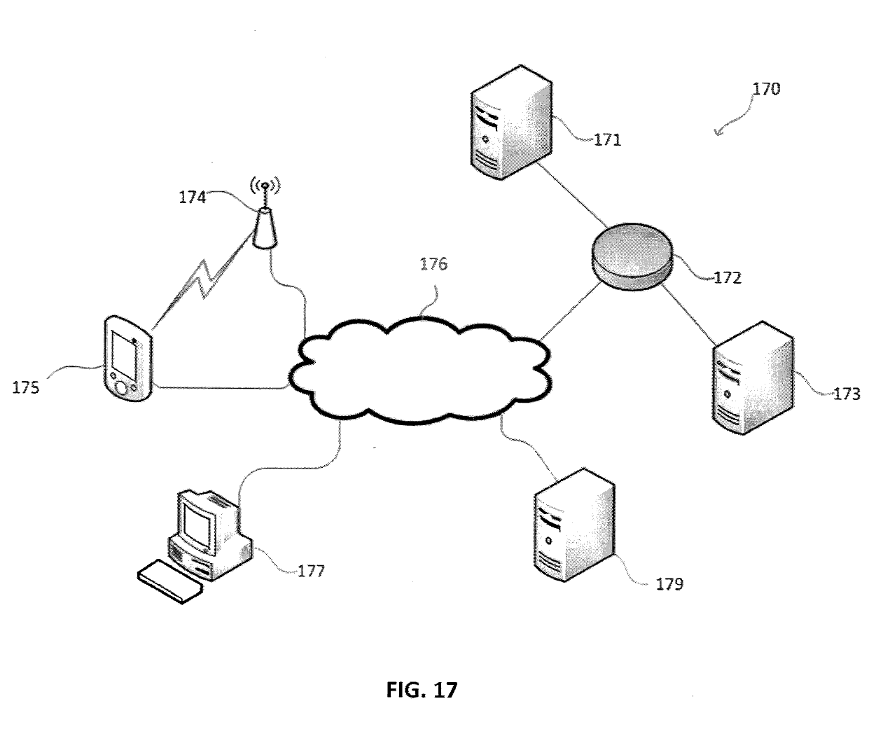

As shown, for example, in FIG. 17, the method and system for real-time monitoring of subscribed activity may be represented as a system 170. In one embodiment, the system 170 comprises a data store 171, a network 172, a data broker 173, a mobile network 174, a user device 175, the Internet 176, a user computer 177, and one or more data sources 179.

In one embodiment, the system 170 may include a data store 171, a network 172, and a data broker 173. The data store 171 is connected to the data broker 173 through a network 172. The network 172 may include, but is not limited to, a local area network and wide area network.

In one embodiment, the data store 171 pulls data or is pushed data from the one or more data sources 179 through communication over the Internet 176 and the network 172. The data store 171 filters and processes the data, and determines whether the filtered data matches any communication flows subscribed to by a user. If the data store 171 determines that a match exists between the filtered data and one or more communication flows of a user, then the data store 171 generates an event for the filtered data. The data store 171 communicates with the data broker 173 through the network 172 to push events to the data broker 173.

In one embodiment, the data broker 173 pushes events to a user communicating through the network 172 and the Internet 176. The user may receive events from the data broker 173 an application and/or web browser on a user device 175 or a user computer 177.

It should be appreciated that the data broker 173 may push events to the user's device 175 through a mobile network 174. The mobile network may include, but is not limited to, a LTE network, HSPA(+) network, GSM network, EVDO network, EDGE network, GPRS network, and any other mobile network for data known to one of ordinary skill in the art. The user's device may include a smartphone, tablet PC, tablet, cell phone, PDA, laptop computer with a mobile network card, and any other device that may be present on a mobile network known to one or ordinary skill in the art.

It should be appreciated that the network 172 is not a critical component to the system. The data store 171 and the data broker 173 may be directly connected to the Internet 176 without the need for a network 172. It also should be appreciated that the data store 171 and the data broker 173 may reside on the same device which is directly connected to the Internet 176 instead of residing on separate devices.

The Internet 176 connects the network 172 with the one or more data sources 179, the user computer 177, and the user device 175. The one or more data sources 171 may include, but are not limited to, Twitter® Feeds, Facebook®, Point-of-Sale (POS) locations, Web Analytics, Location-based Networks, Customer Relationship Management (CRM) tools, Enterprise Resource Planning (ERP), email distributions, mobile distributions, and other information sources. The one or more data sources 171 communicate with the data store to push data or the data store 171 pulls data from the one or more data sources 179.

It should be appreciated that the method for allowing users to target specific communications for monitoring also includes displaying at least a portion of the filtered data in real-time or near real-time within a module, portal, or other display environment. The display step may occur locally or remotely relative to the location of the execution of the other steps in the method. For example, as mentioned above, filtered data may be pushed to an end user or pulled by an end user. As such, the end user may access the filtered information at any location with various types of devices.

Each of the steps described above for the method of allowing users to target specific communications for monitoring may be automated, although one or more of the steps may not be automatic or automated. The automation of the steps eliminates the human error of accidentally failing to monitor the incoming communications. As described below, the method may be implemented into a computer-readable storage medium and be carried out with the aid of a computer.

A computer-readable storage medium, such as a non-volatile storage medium, may comprise the steps of the method described above. The computer program may be generated in any software language or framework such as C#, COBOL, C++, Java, Microsoft® .NET Framework or the like.

The computer-readable medium for performing the embodiments of the present disclosure may include computer-readable program code portions, such as a series of computer instructions, embodied in the computer-readable medium. It should be understood that the computer-readable program code portions may include separate executable portions for performing distinct functions to accomplish embodiments of the present disclosure. Additionally, or alternatively, one or more of the computer-readable program portions may include one or more executable portions for performing more than one function to thereby accomplish embodiments of the process of the present disclosure.

In conjunction with the computer-readable storage medium, a computer that includes a processor, such as a programmable-variety processor responsive to software instructions, a hardwired state machine, or a combination of these may be used to carryout the method disclosed above. Such computers may also include memory, which in conjunction with the processor is used to process data and store information. Such memory can include one or more types of solid state memory, magnetic memory, or optical memory, just to name a few. By way of non-limiting example, the memory can include solid state electronic random access memory (RAM); sequential access memory (SAM), such as first-in, first-out (FIFO) variety or last-in, first-out (LIFO) variety; programmable read only memory (PROM); electronically programmable read only memory (EPROM); or electronically erasable programmable read only memory (EEPROM); an optical disc memory (such as a DVD or CD-ROM); a magnetically encoded hard disc, floppy disc, tape, or cartridge media; or a combination of these memory types. In addition, the memory may be volatile, non-volatile, or a hybrid combination of volatile and non-volatile varieties. The memory may include removable memory, such as, for example, memory in the form of a non-volatile electronic memory unit; an optical memory disk (such as a DVD or CD ROM); a magnetically encoded hard disk, floppy disk, tape, or cartridge media; or a combination of these or other removable memory types.

The computers described above may also include a display upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Such computers may also include one or more data entry, such as, for example, a keyboard, keypad, pointing device, mouse, touchpad, touchscreen, microphone, and/or other data entry means known in the art. Each computer also may comprise an audio display means such as one or more loudspeakers and/or other means known in the art for emitting an audibly perceptible output.

The Pulse Data tool may be based on any development platform, such as Microsoft® .NET. The Pulse Data tool generally allows users to monitor activities that they have an interest in following without the need for an IT administrator by providing a user-friendly application and automating many of the steps of operation.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended concepts. Furthermore, this application is intended to cover such departures from the present disclosure as come within known or customary practice in the art to which this disclosure pertains.

What is claimed is:

1. A method for determining and delivering relevant campaign information from remote data sources in real-time or near real-time, the method comprising:
obtaining data from a plurality of remote data sources on a network;
processing the data from the remote data sources to determine relevant campaign information for a user, wherein the step of processing the data comprises categorizing the data based upon the type of data, filtering the data based on the one or more communication flows subscribed to by the user, and correlating the data; and
delivering the processed data associated with the one or more communication flows to the user.

2. The method of claim 1, further comprising displaying the processed data via a web portal and/or mobile application.

3. The method of claim 1, wherein the step of obtaining data comprises receiving a first set of data at a first time and a second set of data at a second time and associating the first set of data with the first time and the second set of data with the second time, and wherein the step of processing the data comprises determining whether any portion of the second set of data is not found in the first set of data based upon a comparison of the first time and the second time and a comparison of the first set of data and the second set of data.

4. The method of claim 1, wherein the step of obtaining data comprises interfacing with one or more application programming interfaces.

5. The method of claim 1, wherein the step of obtaining data comprises receiving data from the plurality of data sources.

6. The method of claim 1, further comprising displaying the processed data in a module on a web portal and/or mobile application.

7. The method of claim 1, further comprising defining a notification threshold based on the one or more communication flows, wherein the notification threshold defines a limit as to a maximum or minimum value corresponding to the data; and wherein the step of delivering the processed data comprises dispatching an alert to the user when the limit has been met and/or exceeded.

8. The method of claim 1, wherein the one or more communication flows comprises one or more interactions on a social media website, email campaign, and/or point of sale location.

9. The method of claim 1, further comprising placing the data on a data queue;
evaluating the data on the data queue in order to determine whether the data is junk or malformed; and
discarding the data if it is determined to be junk or malformed.

10. The method of claim 3, further comprising aggregating the first set of data with the second set of data; and
wherein the step of delivering the processed data includes sending the aggregated data to the user.

11. A system for the presentation of relevant campaign information in real-time or near real-time, the system comprising:
a data store comprising a server, the server configured to:
obtain data from a plurality of remote data sources on a network;
process the data based on one or more communication flows subscribed to by a user; and
delivering the processed data associated with the one or more communication flows to the user,
wherein the server is electronically coupled to the plurality of remote data sources through an interface, the interface configured to allow the data store to pull data from the plurality of data sources.

12. The system of claim 11, further comprising a data broker configured to receive data from the store and place the data on a data queue, the data broker comprising a server electronically coupled to the data store and the plurality of remote data sources; and
the data broker evaluating the data on the data queue in order to identify and remove unwanted, junk, or malformed data.

13. The system of claim 12, wherein the data broker presents the data associated with the one or more communication flows subscribed to by a user instead of the data store.

14. The system of claim 12, wherein the data broker and the data store reside on the same server.

15. The system of claim 11 or 12, wherein the data store presents the data to a mobile device, user computer, and/or a user device.

16. The system of claim 11 or 12, wherein the user defines a notification threshold based on the one or more communication flows, wherein the threshold defines a limit as to the maximum or minimum value of the data; and
wherein the system notifies the user in the event that the threshold has been met or exceeded, the notification comprising a communication to the user in real time or near-real time on a user device.

17. A method for determining and delivering relevant campaign information from remote data sources in real-time or near real-time, the method comprising:
obtaining a first set of data from a first remote data source on a network;
obtaining a second set of data from a second remote data source on a network;
correlating the first set of data with the second set of data to determine relevant campaign information for a user, wherein the step of correlating the data comprises measuring the first set of data with the second set of data based on one or more communication flows; and
delivering the correlated data associated with the one or more communication flows to the user.

18. The method of claim 17, further comprising obtaining a third set of data from a third remote data source on a network; and correlating the first set of data, the second set of data, and the third set of data to determine relevant campaign information for the user.

19. The method of claim 17, wherein the first remote data source and the second remote data source are the same data source.

20. The method of claim 17, wherein the step of correlating the first set of data with the second set of data includes aggregating the data based on similar information in both the first set of data and the second set of data.

21. A messaging company system comprising:
a contact store for recalling a list of recipient contact information, the contact store comprising a first server configured to store and transmit the list of recipient contact information;
a message builder for building a messaging campaign including messages to recipients of one or more of the following types: email, text, and social media, the message builder comprising a second server electronically coupled to the contact store and configured to build and send messages; and
a status display which provides one or more of the following types of information in real time or near-real time: social media contact activity, clicks of links within text messages, clicks of links within emails, email opens, and email bouncebacks.

22. The system of claim 21, wherein the status display comprises a graphical user interface presented to a user on a mobile application or web portal.

23. The system of claim 21, wherein the status display comprises a notification to a user through email, text, social media, or web browser communication.

24. The system of claim 21, wherein the first server and the second server are the same.

25. The system of claim 21, wherein the message builder and the contact store are electronically coupled to the Internet.
